(19) United States
(12) Patent Application Publication
(10) Pub. No.: US 2007/0010278 A1
(43) Pub. Date: Jan. 11, 2007

(54) System and method for controlling power consumption in a wireless device

(76) Inventors: Anthony D'Agostino, Smithtown, NY (US); George Dellaratta JR., Shirley, NY (US); David Meyer, Levittown, NY (US)

Correspondence Address: FAY KAPLUN & MARCIN, LLP, 15O BROADWAY, SUITE 702, NEW YORK, NY, 10038, US

(21) Appl. No.: 11/157,736

(22) Filed: Jun. 21, 2005

(51) Int. Cl. H04B 7/00; H04Q 7/20

(52) U.S. Cl. 455/522

(57) ABSTRACT

Described is an arrangement including a controlling arrangement, a wireless transceiver and a processor. The wireless transceiver communicates with a wireless device utilizing radio frequency signals at a transmitting power level. The processor collects network performance data (“NPD”) which is indicative of communication with the wireless device. The NPD includes at least one characteristic of the signals. The controlling arrangement adjusts the transmitting power level for the transmission of further radio frequency signals as a function of the NPD and previously collected NPD.

### BACKGROUND

A wireless device, such as a wireless personal data assistant, may transmit and receive data via a wireless network (e.g., an 802.11 wireless LAN network). The wireless network generally includes at least one access point in communication with the wireless device and a server.

An effective transmitting radius of an access point in a wireless network depends in part on a transmitting power level of the access point. The transmitting power level may generally be controlled at the particular access point. For example, the access point with a smaller transmitting radius would generally maintain a lower transmitting power level than the access point with the larger transmitting radius. Therefore, the transmitting power level is kept high enough to effectively communicate with the wireless devices within a desired radius, but low enough not to interfere with communications with neighboring access points and/or wireless networks. However, the wireless devices typically utilize a transmitting power level set at a maximized power level for compatibility with any access point. The transmitting power level in the wireless devices may be adjusted, but is done so via an instruction by the access point to all the wireless devices associated therewith.

### SUMMARY OF INVENTION

The present invention relates to an arrangement including a controlling arrangement, a wireless transceiver and a processor. The wireless transceiver communicates with a wireless device utilizing radio frequency signals at a transmitting power level. The processor collects network performance data (“NPD”) which is indicative of communication with the wireless device. The NPD includes at least one characteristic of the signals. The controlling arrangement adjusts the transmitting power level for the transmission of further radio frequency signals as a function of the NPD and previously collected NPD.

### BRIEF DESCRIPTION OF THE DRAWINGS

FIG. 1 shows an exemplary embodiment of a system according to the present invention;

FIG. 2 shows an exemplary embodiment of a wireless device according to the present invention; and

FIG. 3 shows an exemplary embodiment of a method according to the present invention.

### DETAILED DESCRIPTION

The present invention relates to a system and method for controlling power consumption in a wireless device. In particular, the present invention allows the wireless device to monitor and adjust its transmitting power level as a function of a wireless environment in which the device is operating.

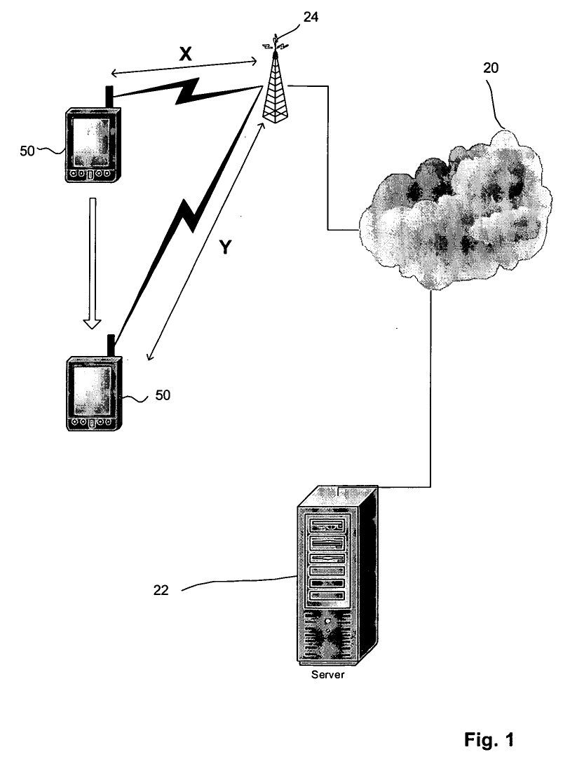

FIG. 1 shows an exemplary embodiment of a system 10 according to the present invention. The system 10 includes a communications network 20 which may include, for example, a local area network (“LAN”), an Intranet, a wireless LAN (“WLAN”) such as 802.11, 802.15, 802.16, 802.20 or any other IP wireless LAN, a wired/wireless wide area network, the Internet, or a cellular network. The system 10 may also include a server 22 and at least one access point 24 (“AP”) coupled to the network 20. The AP 24 may correspond to a cell of the system 10. One of ordinary skill in the art will understand that the system 10 may include any number of APs 24 and/or cells and that instead of the AP 24, there may be a conventional computing device utilizes a wireless transducer for wireless communications.

The system 10 may include a plurality of computing devices having wireless communication capability, such as a wireless device (“WD”) 50. The WD 50 may have voice, data and/or video capabilities and may be, for example, a radio or mobile phone, a personal data assistant (“PDA”), or a portable computer (e.g., including a wireless network interface card coupled to a PC or a mobile processor having an integrated wireless LAN solution). The WD 50 may also include a conventional barcode scanner (e.g., image based and/or laser based) and/or RFID reader. The WD 50 may be capable of wirelessly communicating with the AP 24 using radio frequency (“RF”) signals.

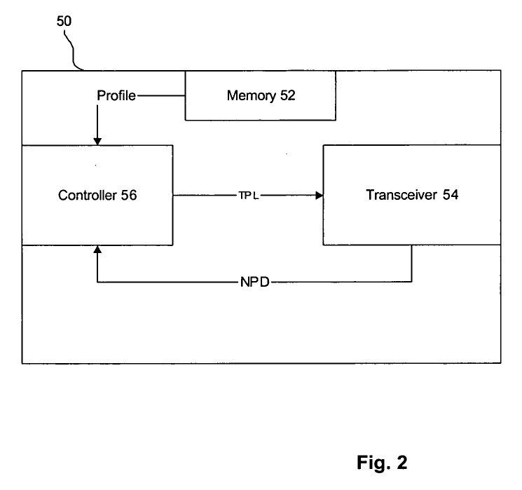

As shown in FIG. 2, the WD 50 may include a memory 52, a wireless transceiver 54, a controlling arrangement (e.g., a controller 56) and any other conventional components required for operation. The memory 52 may be a volatile or non-volatile memory arrangement, or any combination thereof. The transceiver 54 allows the WD 50 to send and receive RF signals in accordance with a predetermined wireless protocol (e.g., an IEEE 802.11 protocol). The controller 56 allows the WD 50 to vary a transmitting power level (“TPL”) as a function of a network performance data (“NPD”) generated by the controller 56, and updated by the transceiver 54, as will be described below.

The NPD may include one or more statistics reflecting the communication between the WD 50 and the AP 24. The statistics may include, but are not limited to, a received signal strength indicator (“RSSI”), a packet error rate, a data throughput rate, a beacon error rate and a signal-to-noise ratio. The NPD may be affected by, for example, an obstruction(s) between the WD 50 and the AP 24, a distance to the AP 24, a number of further WD communicating with the AP 24 or any other condition affecting communication between the WD 50 and the AP 24. Those of skill in the art will understand that the transceiver 54 may generate the NPD dynamically during operation of the WD 50.

In an exemplary embodiment, as shown in FIG. 1, the transceiver 54 receives a signal from the AP 24. Based upon analysis of the signal, the transceiver 54 generates the NPD. For example, as the WD 50 moves from a distance X to a distance Y away from the AP 24, the RSSI may decrease. As such, the TPL may have to be increased to maintain a connection with the AP 24. The NPD may be analyzed by the controller 56 at a predetermined rate (e.g., 1 time per second). The controller 56 may adjust the TPL as a function of the NPD. Those of skill in the art will understand that the rate may be adjusted as a function of the wireless environment. For example, in a more dynamic wireless environment, the WD 50 may utilize an increased rate (e.g., 2-3 times per second).

In one embodiment, the controller 56 applies a weighting factor to at least one of the statistics in the NPD to compute a weighted NPD which may be used to determine whether the TPL should be adjusted. Each weighting factor may be determined as a function of the wireless environment and/or operating parameters of the WD 50. As understood by those of skill in the art, some of the statistics (e.g., the packet error rate and the beacon error rate) are lagging indicators, whereas other statistics (e.g., the RSSI, the signal-to-noise ratio and the data throughput rate) are leading indicators. In one embodiment, the lagging indicators may have a substantially immediate effect on the NPD. In this embodiment, the leading indicators may be substantially volatile and may be buffered to smooth out control of the NPD. Thus, a smaller weight may be assigned to the leading indicators relative to the lagging indicators. However, those of skill in the art will understand that the weighting factors may be determined in any manner to generate a corresponding effect on the TPL.

In another embodiment of the present invention, the memory 52 of the WD 50 may store one or more operation profiles which may be utilized to further control the TPL. Each profile may define an operating parameter(s) specific to the WD 50 and/or an application executed thereby. For example, the WD 50 may utilize a first profile when transmitting voice data to the AP 24 and a second profile when scanning barcodes, each of the profiles utilizing a different TPL. The profiles stored in the memory 52 may include varying combinations of a performance feature and a power-saving feature. For example, in one exemplary profile, the WD 50 may provide a more modest reduction in the TPL to preserve a higher data throughput rate and/or a transmission range.

Prior to and/or during operation of the WD 50, the TPL may be adjusted manually by a user or automatically as a function of the NPD and/or the profile. For example, the TPL may be manually adjusted when the user enters an instruction for the WD 50 to utilize a particular profile. In this embodiment, the WD 50 may utilize a default operation profile and/or a default TPL. The default profile and/or TPL may be displayed to the user via a display (e.g., LCD) on the WD 50. Thus, upon powering up or during operation, the user may desire to change the profile and/or the TPL because, for example, the WD 50 is switching functions (i.e., data transfer to data collection) or the battery substantially depleted. If the user notices or is alerted that the battery is depleted, the user may manually switch the WD 50 to a lowest TPL or the profile which utilizes the lowest TPL.

For automatic adjustment of the TPL, the WD 50 may utilize the weighted NPD and/or the profile. For example, during wireless communications with the AP 24, the transceiver 54 generates and updates the NPD. As described above, the RSSI may change as a result of movement of the WD 50 with respect to the AP 24. Thus, as the WD 50 moves, the transceiver 54 may update, continuously or at predefined intervals, the NPD as signals are received from the AP 24. The controller 56 may then calculate and utilize the weighted NPD and/or the profile to adjust the TPL for further transmissions to the AP 24. As stated above, the NPD may be analyzed according to the predetermined sampling rate. Thus, in one embodiment, the controller 56 does not adjust the TPL until the NPD and/or the profile indicate that a further adjustment should be made to the TPL.

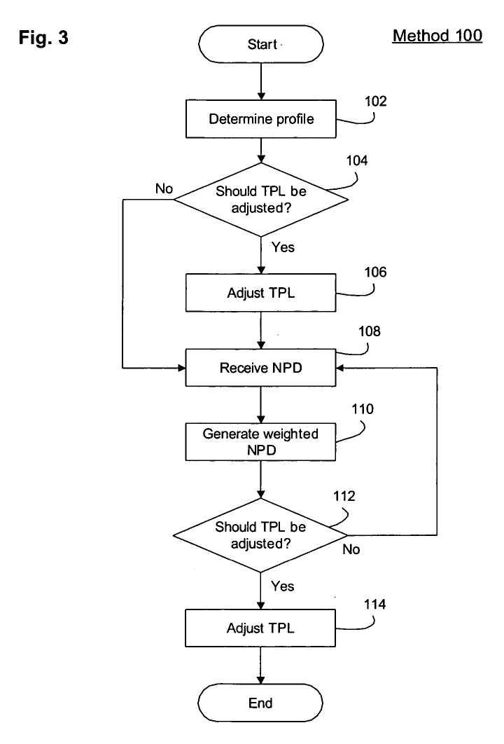

FIG. 3 shows an exemplary embodiment of a method 100 according to the present invention for controlling the TPL utilized by the WD 50. According to the present invention, the WD 50 may adjust the TPL after powering up the WD 50 and or while a wireless connection is maintained with the AP 24. That is, during a wireless communication session (e.g., 802.11 frame transfer), the WD 50 may adjust the TPL on a per-transmission basis, if necessary. That is, the TPL may be adjusted after each signal is received from the AP 24.

In step 102, the profile utilized by the WD 50 is determined. In this manner, upon powering up or receiving the instruction from the user, the controller 56 may access the memory 52 and retrieve the profile stored therein. As described above, the memory 52 may store a plurality of profiles. In one embodiment, as described above, the WD 50 may utilize the default profile after it is powered up. The default profile, or any profile utilized upon powering up, may include the default TPL. Even if the WD 50 does not utilize any profile, the default TPL may nevertheless be utilized. That is, upon powering up, the TPL may be set to the default TPL, regardless of the profile.

In step 104, the controller 56 determines whether the default TPL should be adjusted based on the profile. As noted above, the user may enter the instruction to change the profile to a new profile, which may utilize a new TPL. Further, during a prior use, the WD 50 may have utilized a first TPL, and upon powering up, remain set at the first TPL. However, upon powering up, the user may have entered the new profile which utilizes a second TPL. In this embodiment, the second TPL of the new profile may override the first TPL (or the default TPL). If the TPL should be adjusted, the controller 56 induces the adjustment (step 106).

In step 108, the controller 56 receives the NPD from the transceiver 54. As described above, the transceiver 54 may continually update the NPD during wireless communication with the AP 24. In one embodiment, the controller 56 may analyze the NPD according to the predetermined rate. As described above, the rate may be adjusted manually and/or automatically as a function of activity in the wireless environment. For example, if the controller 56 notices a predetermined fluctuation in one or more of the statistics in the NPD, the controller 56 may automatically adjust the rate accordingly. That is, in the more dynamic and/or congested wireless environment, the rate may be increased (e.g., more times per interval).

In step 110, optionally, the weighting factors are applied to the NPD to compute the weighted NPD. In one embodiment, each profile includes a unique set of weighting factors. For example, in a first profile, an increased weight may be applied to the RSSI, whereas in a second profile, the increased weight is applied to the packet error rate. In another embodiment, the weighting factors are universal for all of the profiles. That is, any profile utilized by the WD 50 does not affect the weighting factors.

In step 112, the controller 56 determines whether the weighted NPD and/or the profile indicate that the TPL should be adjusted. In step 114, the TPL is adjusted based on the weighted NPD and/or the profile. If no adjustment to the TPL was necessary, the controller 56 may wait for the sampling interval before receiving the updated NPD. In one embodiment, a priority may be attached to the weighted NPD and the profile. For example, if the weighted NPD indicates that the TPL should be increased three-fold, while the profile indicates that the TPL should never be greater than two-fold, the priority of each may be analyzed to determined the adjustment which will be executed. In another embodiment, the profile may set limits for the TPL. For example, the weighted NPD may indicate that the TPL should be set at a maximum TPL that the WD 50 is capable of, but the profile indicates that a corresponding maximum TPL is one level below the maximum TPL. In this embodiment, the controller 56 may set the TPL at the corresponding maximum TPL indicated by the profile.

From the above description, those of skill in the art will understand that the present invention provides various advantages in terms of power control for the WD 50. That is, the WD 50 typically utilizes a conventional battery for power. Thus, transmission at the maximum TPL at all times severely drains the battery, limiting a time of use of the WD 50 and a productivity/efficiency thereof. The present invention allows the WD 50 to react individually to the wireless environment. Each device may control its own TPL without relying on an instruction from the AP 24. Thus, the WD 50 may use only as much power as is necessary to sustain a reliable connection to the network.

Another advantage to dynamic individual control of the TPL by the WD 50 is a reduction in contamination of an RF spectrum. Using only as much power as is required for a particular transmission, each WD will emit a reduced amount of RF energy as compared to transmissions at the maximum TPL. In this manner, a cross channel interference may be reduced, improving the data throughput rate and reducing the packet error rate.

While specific embodiments of the invention have been illustrated and described herein, it is realized that numerous modifications and changes will occur to those skilled in the art. It is therefore to be understood that the appended claims are intended to cover all such modifications and changes as fall within the true spirit and scope of the invention.

What is claimed is:

1. An arrangement, comprising:
a controlling arrangement;
a wireless transceiver communicating with a wireless device utilizing radio frequency signals at a transmitting power level; and
a processor collecting network performance data (“NPD”) indicative of communication with the wireless device, the NPD including at least one characteristic of the signals,
wherein the controlling arrangement adjusts the transmitting power level for the transmission of further radio frequency signals as a function of the NPD and previously collected NPD.

2. The arrangement according to claim 1, wherein the arrangement is one of a laser-based scanner, an image-based scanner and an RFID reader.

3. The arrangement according to claim 1, wherein the characteristic is one of a received signal strength indicator, a packet error rate, a data throughput rate, a beacon error rate and a signal-to-noise ratio.

4. The arrangement according to claim 1, wherein the wireless transceiver updates the NPD during the communication.

5. The arrangement according to claim 1, wherein the processor collects the NPD at a predetermined rate.

6. The arrangement according to claim 1, wherein the processor applies a weighting factor to each characteristic.

7. The arrangement according to claim 1, further comprising:
a memory storing at least one operation profile.

8. The arrangement according to claim 7, wherein the operation profile defines a limit for the transmitting power level.

9. The arrangement according to claim 8, wherein the controlling arrangement is prohibited from adjusting the transmitting power level beyond the limit.

10. A method, comprising:
communicating with a wireless device utilizing radio frequency signals at a transmitting power level; and
collecting network performance data (“NPD”) indicative of communication with the wireless device, the NPD including at least one characteristic of the signals,
adjusting the transmitting power level for the transmission of further radio frequency signals as a function of the NPD and previously collected NPD.

11. The method according to claim 10, wherein the characteristic is one of a received signal strength indicator, a packet error rate, a data throughput rate, a beacon error rate and a signal-to-noise ratio.

12. The method according to claim 10, further comprising:
updating the NPD continuously during the communication.

13. The method according to claim 10, wherein the collecting step is performed at a predetermined rate.

14. The method according to claim 10, further comprising:
applying a weighting factor to each characteristic.

15. The method according to claim 10, further comprising:
retrieving an operation profile from a memory.

16. The method according to claim 15, wherein the operation profile defines a limit for the transmitting power level.

17. The method according to claim 16, wherein the adjusting step further includes:
adjusting the transmitting power level as a function of the limit.

18. A system, comprising:
a first wireless device; and
a second wireless device communicating with the first wireless device utilizing radio frequency signals at a transmitting power level,
wherein the second wireless device collects network performance data (“NPD”) indicative of communication with the first wireless device, the NPD including at least one characteristic of the signals,
wherein the second wireless device adjusts the transmitting power level for the transmission of further radio frequency signals as a function of the NPD and previously collected NPD.

19. The system according to claim 18, wherein the first wireless device is an access point and the second wireless device is one of a laser-based scanner, an image-based scanner and an RFID reader.

20. The system according to claim 18, wherein the characteristic is one of a received signal strength indicator, a packet error rate, a data throughput rate, a beacon error rate and a signal-to-noise ratio.
